(19) United States
(12) Patent Application Publication
(10) Pub. No.: US 2026/0202328 A1
(43) Pub. Date: Jul. 16, 2026

(54) OPTICAL ANALYSIS DEVICE, OPTICAL ANALYSIS METHOD, AND PROGRAM FOR OPTICAL ANALYSIS DEVICE

(71) Applicant: HORIBA, LTD., Kyoto-shi, Kyoto (JP)

(72) Inventor: Takashi SAITO, Kyoto-shi, Kyoto (JP)

(73) Assignee: HORIBA, LTD., Kyoto-shi, Kyoto (JP)

(21) Appl. No.: 19/134,700

(22) PCT Filed: Jul. 20, 2023
(86) PCT No.: PCT/JP2023/026667

§ 371 Date: May 30, 2025

(30) Foreign Application Priority Data
Dec. 19, 2022 (JP) 2022-202547

(51) Int. Cl. G01N 21/35

(52) U.S. Cl. CPC G01N 21/35; G01N 2021/3595; G01N 2201/0636; G01N 2201/105

(57) ABSTRACT

An optical analysis device that analyzes a target component by guiding light emitted from a light source to a measuring cell and detecting light transmitted through the measuring cell by a detector, the optical analysis device includes a moving mirror that reflects the light emitted from the light source while reciprocating, a moving mechanism that reciprocates the moving mirror, a movement control unit that controls an applied voltage or an applied current to the moving mechanism, and a cause estimation unit that estimates a cause of an abnormality affecting the moving mirror by using actual waveform data indicating an applied voltage or an applied current to the moving mechanism at each time and reference waveform data acquired in advance and indicating an applied voltage or an applied current to the moving mechanism at each time.

### TECHNICAL FIELD

The present invention relates to an optical analysis device, an optical analysis method, and a program for an optical analysis device.

### BACKGROUND ART

As a conventional optical analysis device, as disclosed in Patent Literature 1, there is an optical analysis device that measures a light intensity spectrum using an FTIR interferometer to analyze a concentration of a component to be measured.

The measurement accuracy of the light intensity spectrum depends on the accuracy of constant speed control of a moving mirror when the interferogram waveform serving as the original is sampled.

Therefore, in order to ensure the measurement accuracy of the light intensity spectrum, not only mechanical, electrical, and software are designed so that the moving mirror can be controlled at a constant speed, but also accuracy management is performed to suppress variations that may occur at the time of assembling or adjusting the device.

As such management, for example, the speed stability in the constant speed control section of the mirror is checked, and the presence or absence of sound, vibration, or the like at the time of controlling the moving mirror is checked. In a case where there is a problem in these accuracy management indices, a problem at the time of assembly or adjustment is investigated and corrected.

However, even if it is found that a problem has occurred due to such accuracy management, the information is insufficient to estimate the cause, and as a result, much time is spent to identify the cause and implement measures when the problem occurs.

### CITATION LIST

### Patent Literature

Patent Literature 1: JP 2016-090472A

### SUMMARY OF INVENTION

### Technical Problem

Therefore, the present invention has been made to solve the above-described problem, and a main object thereof is to enable estimation of a cause in a case where a problem occurs in movement of a moving mirror.

### Solution to Problem

That is, an optical analysis device according the present invention is an optical analysis device that analyzes a target component by guiding light emitted from a light source to a measuring cell and detecting light transmitted through the measuring cell, the optical analysis device includes: a moving mirror that reflects light emitted from the light source while reciprocating; a moving mechanism that reciprocates the moving mirror; a movement control unit that controls an applied voltage or an applied current to the moving mechanism; and a cause estimation unit that estimates a cause affecting movement of the moving mirror by using actual waveform data indicating an actual applied voltage or an applied current to the moving mechanism at each time and reference waveform data acquired in advance and indicating an applied voltage or an applied current to the moving mechanism at each time.

Here, a reference waveform indicated by reference waveform data is a waveform acquired in advance at a normal time or after maintenance, and indicates an ideal behavior of an applied voltage or an applied current in a case where no abnormality occurs in the device.

On the other hand, an actual waveform indicated by actual waveform data indicates an actual behavior at the time of measuring an applied voltage or an applied current applied to the moving mechanism so as to reduce the difference between the actual position of the moving mirror and the target position.

Therefore, in a case where an abnormality occurs in the device and the abnormality causes a problem in the movement of the moving mirror, the actual waveform deviates from the reference waveform.

The deviation varies depending on an abnormal portion of the device, for example, the entire waveform shifts up and down, or the height and smoothness of the peak change.

Therefore, the optical analysis device according to the present invention includes a cause estimation unit that estimates a cause affecting the movement of the moving mirror using the actual waveform data and the reference waveform data. Therefore, in a case where a problem occurs in the movement of the moving mirror, the cause of the problem can be estimated differently from the conventional case.

As a specific aspect of the above-described cause estimation unit, it is preferable to output, as a cause of the abnormality, information on a driving source constituting the moving mechanism, information on a frictional force generated by movement of the moving mirror, or information on a force applied to the moving mirror regardless of a position of the moving mirror that is reciprocating, and to further include a cause output unit that outputs a cause estimated by the cause estimation unit.

With such a configuration, a user can quickly grasp the cause of the abnormality.

It is preferable that a position of the moving mirror at each time and an applied current or an applied voltage to the moving mechanism at each time can be expressed using a predetermined transfer function, and the transfer function includes a plurality of parameters corresponding to a plurality of types of the causes, and the cause estimation unit estimates the cause by comparing each value of the parameters of the transfer function obtained using the reference waveform data with each value of the parameters of the transfer function obtained using the actual waveform data.

In this case, an abnormal portion or the like can be estimated depending on which parameter has a difference.

The correlation between the applied voltage and the target position of the moving mirror is not expressed by a simple proportional formula, but is complicated, and the actual waveform data also includes the influence of measurement noise and the like, so that it is difficult to accurately obtain the value of the parameter described above by simple calculation.

Therefore, it is preferable to include an actual parameter value acquisition unit that acquires an actual parameter value that is a value of a parameter of the transfer function by fitting the transfer function to the actual waveform data.

With such a configuration, the accuracy of the acquired actual parameter value is improved, and an abnormal portion or the like can be estimated more correctly.

Here, as described in the background art, since accuracy of constant speed control is important in the FTIR interferometer, it is likely to consider that a waveform in a constant speed control section of the moving mirror is important.

However, even when the actual waveform and the reference waveform in the constant speed control section are compared, the amount of information is small, and it is difficult to estimate an abnormal portion or the like.

Therefore, as a result of intensive studies by the inventor of the present application, the waveform in the section including the turning point of the reciprocating moving mirror is more complicated than the waveform in the constant speed control section, and various abnormality causes appear in the deviation between the actual waveform and the reference waveform in this section in an identifiable manner.

Therefore, it is preferable that the actual parameter value acquisition unit fits the transfer function to a transient section included in the actual waveform indicated by the actual waveform data.

In this case, since the transient section included in the actual waveform corresponds to the section including the turning point of the moving mirror, various abnormality causes can be estimated more correctly.

It is preferable that one of the plurality of parameters is a parameter that varies according to a deviation from a theoretical value of a driving force output from the moving mechanism to the moving mirror.

In this case, in a case where there is a difference in this parameter, for example, a driving source such as a coil constituting the moving mechanism can be estimated as an abnormality cause.

It is preferable that one of the plurality of parameters is a parameter that varies according to a frictional force generated by movement of the moving mirror.

In this case, in a case where there is a difference in this parameter, for example, a guide supporting the moving mirror can be estimated as an abnormality cause.

It is preferable that one of the plurality of parameters is a parameter that varies according to a force applied to the moving mirror regardless of a position of the moving mirror that is reciprocating.

In this case, in a case where there is a difference in this parameter, it is possible to estimate an abnormality cause such as an inclined portion in the device.

An optical analysis method according to the present invention is a method used by an optical analysis device that analyzes a target component by guiding light emitted from a light source to a measuring cell and detecting light transmitted through the measuring cell, the optical analysis device including: a moving mirror that reflects the light emitted from the light source while reciprocating; and a moving mechanism that reciprocates the moving mirror, the method includes estimating a cause of an abnormality affecting the moving mirror using actual waveform data indicating an applied voltage or an applied current to the moving mechanism at each time and reference waveform data acquired in advance and indicating an applied voltage or an applied current to the moving mechanism at each time.

A program for an optical analysis device according to the present invention is a program used by an optical analysis device that analyzes a target component by guiding light emitted from a light source to a measuring cell and detecting light transmitted through the measuring cell, the optical analysis device including: a moving mirror that reflects the light emitted from the light source while reciprocating; and a moving mechanism that reciprocates the moving mirror, the program that causes a computer to exert a function as a cause estimation unit that estimates a cause of an abnormality affecting the moving mirror using actual waveform data indicating an applied voltage or an applied current to the moving mechanism at each time and reference waveform data acquired in advance and indicating an applied voltage or an applied current to the moving mechanism at each time.

According to such an optical analysis method and a program for an optical analysis device, it is possible to achieve the similar operational effects to those of the above-described optical analysis device.

In addition, the optical analysis device according to the present invention is an optical analysis device that analyzes a target component by guiding light emitted from a light source to a measuring cell and detecting light transmitted through the measuring cell, the optical analysis device includes: a moving mirror that reflects the light emitted from the light source while reciprocating; a moving mechanism that reciprocates the moving mirror; a movement control unit that controls a position of the moving mechanism; and a cause estimation unit that estimates a cause of an abnormality affecting the moving mirror by using actual waveform data indicating a position of the moving mirror at each time or obtained from the position, and reference waveform data acquired in advance and indicating a target position of the moving mirror at each time or obtained from the target position.

Here, the reference waveform (for example, a waveform indicating a target position, a speed, or the like) is an ideal waveform in a case where no abnormality occurs in the device, and the actual waveform is a waveform deviated from the reference waveform in a case where an abnormality occurs in the device and the abnormality causes a problem in the movement of the moving mirror.

Then, the deviation varies depending on an abnormal portion of the device, for example, the entire waveform shifts up and down, or the height and smoothness of the peak change.

Therefore, since the optical analysis device according to the present invention described above includes the cause estimation unit that estimates the cause of the abnormality affecting the moving mirror using the actual waveform data and the reference waveform data, in a case where a problem occurs in the movement of the moving mirror, it is possible to estimate the cause of the problem unlike the conventional case.

An optical analysis device according to the present invention is an optical analysis device that analyzes a target component by guiding light emitted from a light source to a measuring cell and detecting light transmitted through the measuring cell, the optical analysis device includes: a moving mirror that reflects the light emitted from the light source while reciprocating; a moving mechanism that reciprocates the moving mirror; a movement control unit that controls an applied voltage or an applied current to the moving mechanism; and a comparison output unit that comparably outputs actual waveform data indicating an applied voltage or an applied current to the moving mechanism at each time and reference waveform data acquired in advance and indicating an applied voltage or an applied current to the moving mechanism at each time.

According to the optical analysis device configured as described above, since the above-described actual waveform data and the reference waveform data are comparably output, in a case where a problem occurs in the movement of the moving mirror, it is possible to estimate the cause of the problem unlike the conventional case.

### Advantageous Effects of Invention

According to the present invention configured as described above, in a case where a problem occurs in movement of a moving mirror, it is possible to estimate a cause thereof.

### BRIEF DESCRIPTION OF DRAWINGS

FIG. 1 is a schematic diagram illustrating a configuration of an optical analysis device of the present embodiment.

FIG. 2A is a functional block diagram illustrating a function of a control device of the present embodiment.

FIG. 2B is a functional block diagram illustrating a function of the control device of another embodiment.

FIG. 3 is a graph illustrating a relationship between a target position of a moving mirror and time of the present embodiment.

FIG. 4 is a graph illustrating a relationship between a speed of the moving mirror and time of the present embodiment.

FIG. 5 is a graph illustrating a behavior of actual waveform data of the present embodiment.

FIG. 6 is a flowchart illustrating an operation of the control device of the present embodiment.

FIG. 7 is a graph explaining fitting based on an actual parameter value of the present embodiment.

### DESCRIPTION OF EMBODIMENTS

Hereinafter, an embodiment of an optical analysis device according to the present invention will be described with reference to the drawings.

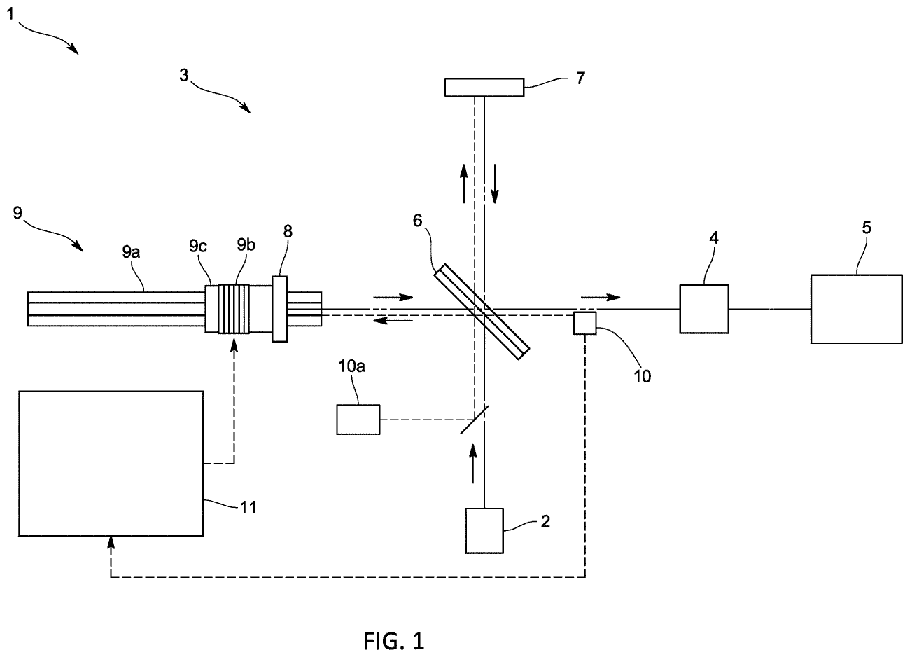

An optical analysis device 1 of the present embodiment is a Fourier transformation type infrared spectroscopic analysis device called FTIR, and includes an infrared light source 2, an interferometer 3, a measuring cell 4, and an analysis unit 5 as illustrated in FIG. 1.

With the above-described configuration, the measurement sample housed in the measuring cell 4 is irradiated with the infrared light emitted from the infrared light source 2 via the interferometer 3, and the analysis unit 5 detects and disperses the transmitted light transmitted through the measurement sample, whereby the analysis unit 5 detects a spectrum specific to the measurement sample to analyze the measurement sample.

As illustrated in FIG. 1, the interferometer 3 includes a beam splitter 6, a fixed mirror 7, a moving mirror 8, a moving mechanism 9 that reciprocates the moving mirror 8, a measurement unit 10 that measures a moving speed of the moving mirror 8, and a control device 11 that controls the moving mechanism 9 to reciprocate the moving mirror 8 at a constant speed.

The beam splitter 6 is formed by coating a parallel plate made of a crystal such as KBr having infrared transparency with a thin film made of Ge or the like, and transmits and reflects light emitted from the light source 2. Therefore, the light emitted from the light source 2 and passed through the beam splitter 6 is split into two paths, an optical path toward which the transmitted light travels and an optical path toward which the reflected light travels.

The fixed mirror 7 is disposed on one of the optical paths split by the beam splitter 6, and is disposed on the optical path of the light transmitted by the beam splitter 6 in the present embodiment.

The moving mirror 8 is disposed on the other of the optical paths split by the beam splitter 6, and is disposed on the optical path of the light reflected by the beam splitter 6 in the present embodiment.

The moving mechanism 9 includes a power source that outputs power for moving the moving mirror 8. Examples of such a power source include power sources that output mechanical, electrical, magnetic, or fluid driving force, and more specifically, power sources configured using a motor, a pneumatic valve, a solenoid, or the like.

As illustrated in FIG. 1, the moving mechanism 9 includes a linear motion guide 9a provided with a rail in the long axis direction, a base 9c that moves along the rail of the linear motion guide 9a and on which the moving mirror 8 is mounted, a coil 9b wound around the base 9c along the long axis direction of the linear motion guide 9a, and a pair of permanent magnets (not illustrated) disposed along the longitudinal direction so as to interpose the linear motion guide 9a.

The measurement unit 10 is a photosensor that measures the moving speed of the moving mirror 8, and measures the speed from, for example, a frequency change of light emitted from a light source 10a and reflected by the fixed mirror 7 and/or the moving mirror. Then, the measurement unit 10 transmits actual speed data indicating the measured speed to the control device 11.

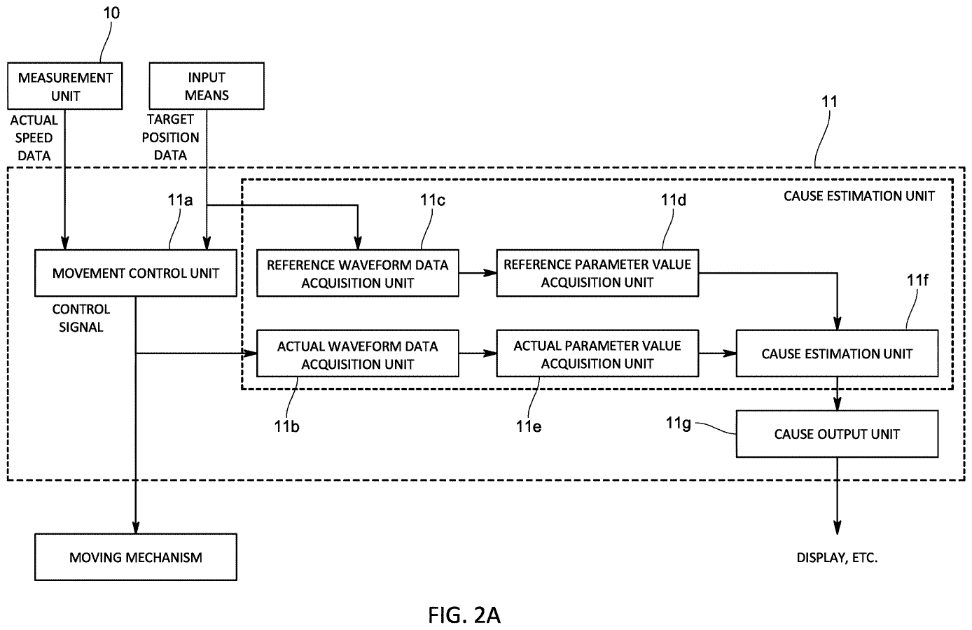

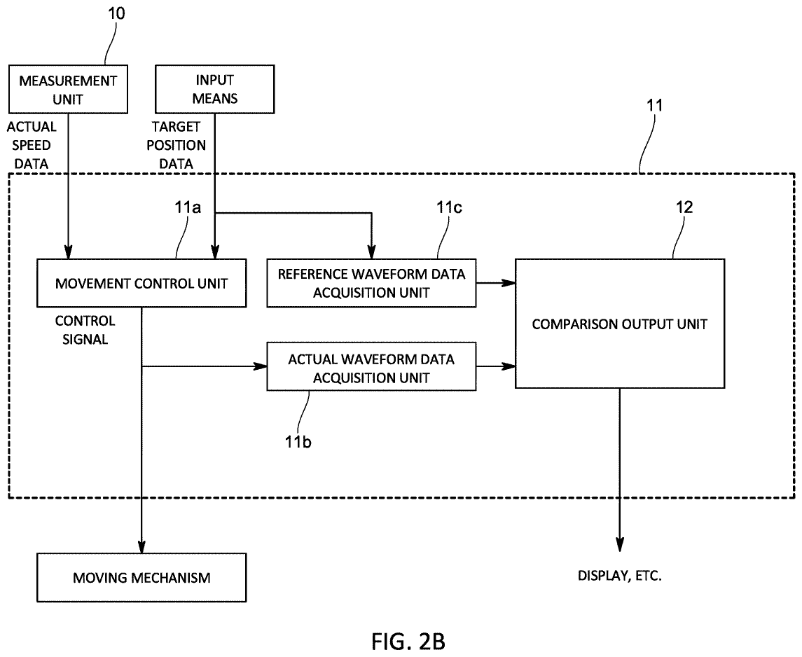

The control device 11 controls the operation of the moving mechanism 9, and is structurally a so-called computer circuit including a CPU, an internal memory, an I/O buffer circuit, an AD converter, and the like. Then, by operating according to a control program stored in a predetermined area of the internal memory, the CPU and the peripheral device operate in cooperation to exert a function as a movement control unit 11a illustrated in FIG. 2.

The movement control unit 11a controls an applied voltage or an applied current to the moving mechanism 9. Specifically, the movement control unit 11a outputs a control signal to a driving source of the moving mechanism 9, and linearly reciprocates the moving mirror 8 by a driving force from the driving source.

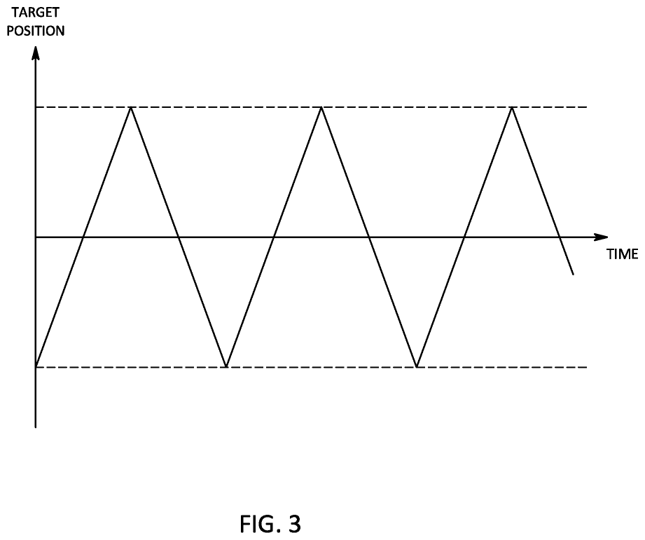

The movement control unit 11a moves the moving mirror 8 at a constant speed in a section excluding a section required for reverse of the moving mirror 8. Specifically, as illustrated in FIG. 3, the movement control unit 11a creates target speed data indicating the target speed by time-differentiating the target position indicated by target position data input in advance via an input means. Then, the movement control unit 11a calculates a deviation between the created target speed data and the actual speed data transmitted from the measurement unit 10, performs arithmetic processing using a feedback expression such as a proportional operation and an integral operation on the deviation to generate a control signal, and transmits the control signal to the moving mechanism 9.

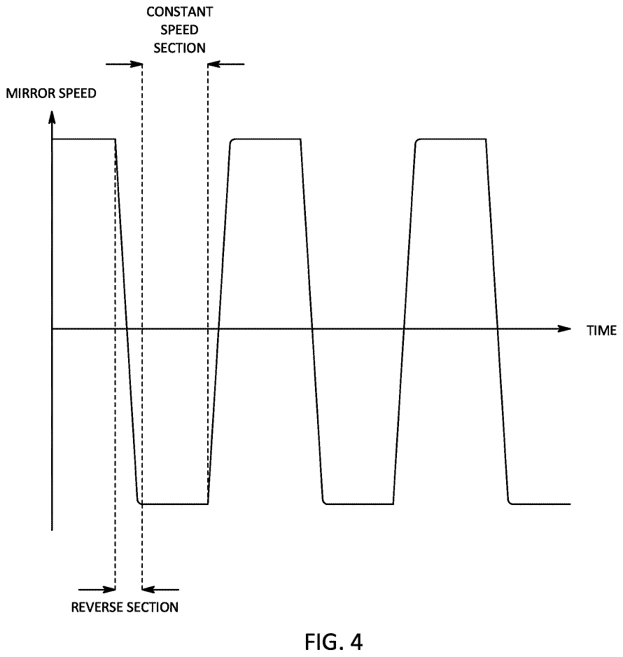

When the vertical axis indicates a position and the horizontal axis indicates time, the above-described target position draws a triangular wave as illustrated in FIG. 3. In the speed at which the moving mechanism 9 is moved so as to follow the target position, when the vertical axis indicates speed and the horizontal axis indicates time, as illustrated in FIG. 4, a constant speed section at a constant speed and a reverse section in which the speed is decelerated from the constant speed and stopped and then accelerated to the same speed as the constant speed are alternately repeated.

The movement control unit 11a moves the moving mechanism 9 along the linear motion guide 9a at a constant speed in the constant speed section, and reverses the moving mechanism 9 at both ends of the linear motion guide 9a in the reverse section. Then, repeating this control by the movement control unit 11a causes the moving mechanism 9 and the moving mirror 8 mounted on the moving mechanism 9 to reciprocate linearly.

The control signal output from the movement control unit 11a to the moving mechanism 9 is a signal indicating the magnitude of an applied current or an applied voltage to be applied to the moving mechanism 9. When the current flows to the coil 9b in response to the control signal, the base 9c linearly reciprocates along the linear motion guide 9a by the force generated by the direction in which the current flows and the magnetic field by the permanent magnet.

With the above-described configuration, the light emitted from the light source 2 is divided into two light fluxes by the beam splitter 6, one light flux is reflected toward the beam splitter 6 by the fixed mirror 7, and the other light flux is reflected toward the beam splitter 6 by the moving mirror 8. At this time, since the moving mirror 8 is linearly reciprocating by the moving mechanism 9, an optical path difference occurs between the light flux reflected by the fixed mirror 7 and the light flux reflected by the moving mirror 8, and these light beams are superimposed by the beam splitter 6 to generate interference light.

Then, as illustrated in FIG. 2, the control device 11 of the present embodiment further includes functions as an actual waveform data acquisition unit 11b and a reference waveform data acquisition unit 11c.

The actual waveform data acquisition unit 11b acquires actual waveform data indicating an applied voltage or an applied current to the moving mechanism 9 at each time at the time of check.

Note that, the time of check means the time of confirming the abnormality in the movement of the moving mirror 8, and specifically, is the timing of moving the moving mechanism 9 at the time of measurement or the timing of moving the moving mechanism 9 before measurement.

The actual waveform data is a temporal change of a value (in this embodiment, an applied voltage or an applied current) indicated by the control signal at each time actually transmitted from the above-described movement control unit 11a to the moving mechanism 9 at the time of measurement of the optical analysis device 1 or the like.

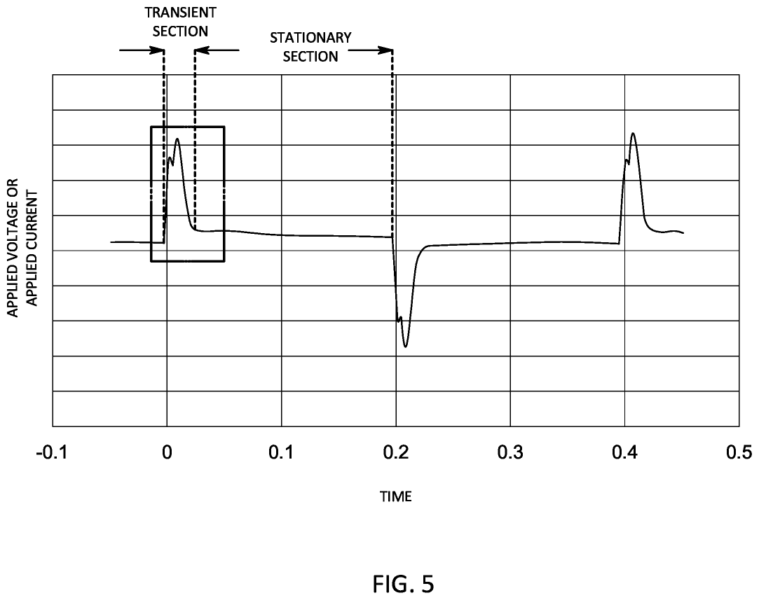

In the behavior indicated by the actual waveform data, when the vertical axis indicates an applied voltage or an applied current and the horizontal axis indicates time, as illustrated in FIG. 5, a stationary section appearing corresponding to the above-described constant speed section and a transient section appearing corresponding to the above-described reverse section are repeated.

The stationary section is a section in which the applied voltage or the applied current has little fluctuation, in other words, a flat section in which the applied current or the applied voltage is stable.

On the other hand, the transient section is a section in which the applied voltage or the applied current greatly fluctuates between the adjacent stationary sections, in other words, a section appearing as an upward or downward peak.

The reference waveform data acquisition unit 11c acquires reference waveform data indicating an applied voltage or an applied current to the moving mechanism 9 at the reference time at each time.

Note that, the reference time means the time when it can be said that at least no abnormality has occurred in the movement of the moving mirror 8. Specifically, the reference time means the time of shipping from the factory, after maintenance, the time of calibration, the time of first use, the time of a predetermined number of times of use, or the time when a predetermined period has elapsed.

That is, the reference waveform data acquisition unit 11c acquires the reference waveform data acquired in advance and indicating an applied voltage or an applied current to the moving mechanism 9 at each time, and more specifically, acquires the reference waveform data acquired before the acquisition of the actual waveform data described above.

The reference waveform data is obtained as no abnormality occurs in the optical analysis device 1 (that is, the optical analysis device 1 is normal), and is a temporal change of a value (in this embodiment, an applied voltage or an applied current) indicated by a control signal transmitted from the movement control unit 11a to the moving mechanism 9 in moving the moving mirror 8 to the target position at each time at the above-described reference time.

In the behavior indicated by the reference waveform data, similarly to the actual waveform data described above, when a vertical axis indicates an applied voltage or an applied current and a horizontal axis indicates time, a stationary section appearing corresponding to the above-described constant speed section and a transient section appearing corresponding to the above-described reverse section are repeated.

Here, there is a correlation between a position Y(s) of the moving mirror 8 at each time and an applied current or an applied voltage U(s) to the moving mechanism 9 at each time, and these position Y(s) and applied current or applied voltage U(s) are expressed by the following Formula (1) using a predetermined transfer function G(s) with s as a parameter.

Y(s)=G(s)·U(s) Formula (1)

Then, the transfer function G(s) includes a plurality of parameters, and the parameters include those corresponding to the cause of the abnormality of the movement of the moving mirror 8, in other words, those whose values vary depending on whether or not the abnormality affecting the movement of the moving mirror 8 occurs.

These parameters correspond to a cause affecting the speed of the moving mirror 8, and more specifically, correspond to a cause of abnormality (hereinafter, also referred to as an abnormality cause) that affects the moving speed of the moving mirror 8 in the constant speed section.

The abnormality affecting the moving speed of the moving mirror 8 herein includes not only an abnormality occurring in the moving mirror 8 itself but also an abnormality occurring in a member around the moving mirror 8.

In addition, the abnormality cause herein is a cause that causes a difference between the behavior indicated by the actual waveform data and the behavior indicated by the reference waveform data, and examples thereof include variations during assembly or manufacturing occurring in the optical analysis device 1 or the interferometer 3.

That is, the values of the above-described parameters vary depending on whether or not an abnormality affecting the moving speed of the moving mirror 8 in the constant speed section occurs.

Examples of such a parameter include a parameter whose value varies according to a deviation from a theoretical value of the driving force output from the moving mechanism 9 to the moving mirror 8 (hereinafter, referred to as a first parameter), a parameter whose value varies according to a frictional force generated by the movement of the moving mirror 8 (hereinafter, referred to as a second parameter), and a parameter whose value varies according to force applied to the moving mirror 8 regardless of the position of the moving mirror 8 that is reciprocating (hereinafter, referred to as a third parameter).

Specific examples of the above-described formula (1) include those expressed by the following formula (1)′.

$$Y ( s ) = \frac{{b}_{0}}{{s}^{2} + {a}_{1} s + {a}_{0}} ( U ( s ) - {d}_{0} ) \qquad Formula ( 1 ) ’$$

The transfer function G(s) here is expressed by a coefficient and a constant term of U(s), and a₀ and b₀ in the transfer function G(s) are first parameters, a₁ is a second parameter, and d₀ is a third parameter.

Note that, the transfer function G(s) may not include a constant term (that is, d₀=0). In addition, the transfer function G(s) described above is expressed as a quadratic expression of the parameter s, but may be expressed as a linear expression of the parameter s or may be expressed as a cubic or higher expression.

Then, the control device 11 of the present embodiment is configured to control the applied voltage or the applied current to the moving mechanism 9, and estimate the cause of the abnormality affecting the moving mirror 8 using the actual waveform data indicating the applied voltage or the applied current to the moving mechanism 9 at each time and the reference waveform data acquired in advance and indicating the applied voltage or the applied current to the moving mechanism 9 at each time.

Specifically, as illustrated in FIG. 2A, the control device 11 has functions as the movement control unit 11a, a reference parameter value acquisition unit 11d, an actual parameter value acquisition unit 11e, and a cause estimation unit 11f. The reference parameter value acquisition unit 11d, the actual parameter value acquisition unit 11e, and the cause estimation unit 11f may be collectively referred to as a cause estimation unit. In this case, the cause estimation unit estimates the cause of the abnormality affecting the moving mirror using the actual waveform data indicating the applied voltage or the applied current to the moving mechanism at each time and the reference waveform data acquired in advance and indicating the applied voltage or the applied current to the moving mechanism at each time.

In addition, as illustrated in FIG. 2B, the control device 11 may be configured to include the reference parameter value acquisition unit 11d, the actual parameter value acquisition unit 11e, and a comparison output unit 12. The comparison output unit 12 comparably outputs the actual waveform data indicating the applied voltage or the applied current to the moving mechanism 9 at each time and the reference waveform data acquired in advance and indicating the applied voltage or the applied current to the moving mechanism 9 at each time.

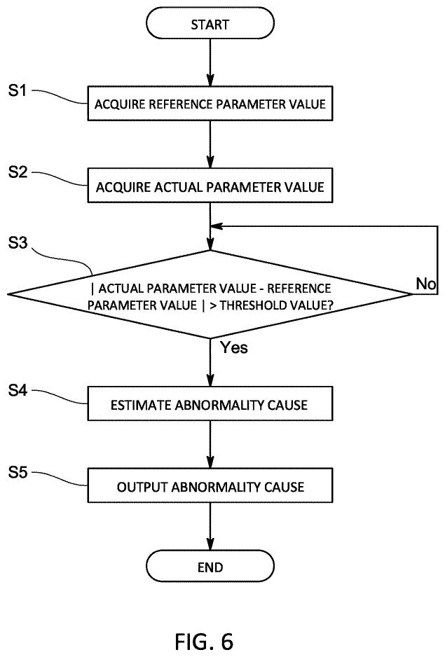

Hereinafter, not only the operation of the control device 11 but also these units will be described with reference to the flowchart of FIG. 6.

The reference parameter value acquisition unit 11d acquires the value of the parameter included in the transfer function G(s) indicating the correlation between the target position data and the reference waveform data as a reference parameter value (S1).

A method of acquiring the reference parameter value is not particularly limited, but an example thereof may include a method of obtaining by optimizing the transfer function G(s) using the target position data and the reference waveform data, and acquiring the value of each parameter included in the optimized transfer function G(s) as the reference parameter value.

More specifically, the reference parameter value acquisition unit 11d fits the transfer function G(s) to the reference waveform data, and acquires, as the reference parameter values, the values of a₀ and b₀, which are the first parameters, a₁, which is the second parameter, and do, which is the third parameter, included in the transfer function G(s) obtained by the fitting.

The actual parameter value acquisition unit 11e acquires the value of the parameter included in the transfer function G(s) indicating the correlation between the above-described target position data and the actual waveform data as an actual parameter value (S2).

A method of acquiring the actual parameter value is not particularly limited, but an example thereof may include a method of obtaining by optimizing the transfer function G(s) using the target position data and the actual waveform data, and acquiring the value of each parameter included in the optimized transfer function G(s) as the actual parameter value.

More specifically, the actual parameter value acquisition unit 11e fits the transfer function G(s) to the actual waveform data, and acquires values of a₀ and b₀, which are the first parameters, a₁, which is the second parameter, and do, which is the third parameter, included in the transfer function G(s) obtained by the fitting as actual parameter values.

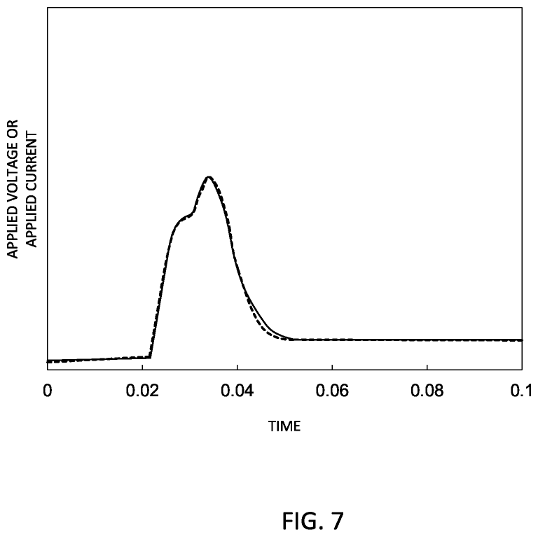

As illustrated in FIG. 7, the actual parameter value acquisition unit 11e of the present embodiment is configured to fit the transfer function G(s) to the transient section appearing in the actual waveform indicated by the actual waveform data.

In FIG. 7, the solid line indicates the waveform of the actual waveform data, and the dotted line indicates the waveform of the fitting data.

The cause estimation unit 11f estimates a cause (hereinafter, also referred to as an abnormality cause) that affects the movement of the moving mirror 8 using the actual waveform data and the reference waveform data. Specifically, the cause estimation unit 11f estimates the abnormality cause using an actual parameter value obtained using the actual waveform data and a reference parameter value obtained using the reference waveform data.

The cause estimation unit 11f of the present embodiment compares each of the actual parameter values with each of the reference parameter values (S3), and estimates the abnormality cause (S4).

More specifically, for example, the cause estimation unit 11f compares the value of the first parameter acquired as the actual parameter value with the value of the first parameter acquired as the reference parameter value described above, and estimates that the abnormality cause related to the deviation from the theoretical value of the driving force output from the moving mechanism 9 to the moving mirror 8 occurs in a case where the difference is equal to or larger than a first threshold value.

Specifically, this abnormality cause occurs, for example, when the driving source constituting the moving mechanism 9 becomes an abnormal portion, and examples thereof include that related to the excitation force of the coil 9b.

That is, in a case where a difference equal to or larger than the first threshold occurs between the value of the first parameter acquired as the actual parameter value and the value of the first parameter acquired as the reference parameter value, the cause estimation unit 11f of the present embodiment estimates that an abnormality occurs in the driving source or the periphery thereof, and outputs the fact to a display or the like by notification and/or display.

In addition, the cause estimation unit 11f compares the value of the second parameter acquired as the actual parameter value with the value of the second parameter acquired as the reference parameter value described above, and estimates that an abnormality cause related to the frictional force generated by the movement of the moving mirror 8 occurs in a case where the difference is equal to or larger than a second threshold value.

Specifically, this abnormality cause occurs, for example, when the linear motion guide 9a constituting the moving mechanism 9 and/or the base 9c on which the moving mirror 8 is mounted becomes an abnormal portion, and examples thereof include a lubricant such as grease interposed between the linear motion guide 9a and the base 9c.

That is, in a case where a difference equal to or larger than the second threshold occurs between the value of the second parameter acquired as the actual parameter value and the value of the second parameter acquired as the reference parameter value, the cause estimation unit 11f of the present embodiment estimates that an abnormality occurs in the linear motion guide 9a, the base 9c, or the periphery thereof, and outputs the fact to a display or the like by notification and/or display.

Furthermore, the cause estimation unit 11f compares the value of a third parameter acquired as the actual parameter value with the value of the third parameter acquired as the reference parameter value described above, and in a case where the difference is equal to or larger than a third threshold value, the cause estimation unit 11f estimates that an abnormality cause related to the force constantly applied to the moving mirror 8 occurs regardless of the position of the moving mirror 8 that is reciprocating.

Specifically, the abnormality cause occurs, for example, when the linear motion guide 9a constituting the moving mechanism 9 and/or the base 9c on which the moving mirror 88 is mounted becomes an abnormal portion, and examples thereof include those caused by an inclination of the base 9c with respect to the linear motion guide 9a and/or an inclination of the linear motion guide 9a itself.

That is, in a case where a difference equal to or larger than the third threshold occurs between the value of the third parameter acquired as the actual parameter value and the value of the third parameter acquired as the reference parameter value, the cause estimation unit 11f of the present embodiment estimates that an abnormality occurs in the installation state of the base 9c with respect to the linear motion guide 9a and/or the installation state of the linear motion guide 9a, and outputs the fact to a display or the like by notification and/or display.

Note that, some or all of the first threshold value, the second threshold value, and the third threshold value may be equal to each other, or some or all of the first threshold value, the second threshold value, and the third threshold value may be different from each other.

Then, as illustrated in FIG. 2, the control device 11 of this embodiment further has a function as a cause output unit 11g that outputs the cause estimated by the cause estimation unit 11f described above.

The cause output unit 11g displays and outputs a part or all of the estimation result by the cause estimation unit 11f on a display or the like (S5).

Specifically, in a case where the difference between the first parameter acquired as the actual parameter value and the first parameter acquired as the reference parameter value is equal to or larger than the first threshold value, the cause output unit 11g outputs information related to the driving source constituting the moving mechanism 9 as the cause of the abnormality.

In addition, in a case where the difference between the second parameter acquired as the actual parameter value and the second parameter acquired as the reference parameter value is equal to or larger than the second threshold value, the cause output unit 11g outputs information related to the frictional force generated by the movement of the moving mirror 8 as the cause of the abnormality.

Furthermore, in a case where the difference between the third parameter acquired as the actual parameter value and the third parameter acquired as the reference parameter value is equal to or larger than the third threshold value, the cause output unit 11g outputs information related to the force applied to the moving mirror 8 as the cause of the abnormality regardless of the position of the moving mirror 8 that is reciprocating.

Note that, the cause output unit 11g may be configured to output an abnormal portion on the basis of the estimation result of the cause estimation unit 11f. Examples of the abnormal portion to be output include components constituting the moving mechanism 9 such as the driving source, the linear motion guide 9a, the coil 9b, and/or the base 9c on which the moving mirror 8 is mounted, and/or the moving mirror 8.

According to the optical analysis device 1 configured as described above, in a case where a problem occurs in the movement of the moving mirror 8, the actual waveform deviates from the reference waveform in various ways according to the abnormality cause of the device. Therefore, the cause estimation unit 11f estimate the abnormality cause using the actual waveform data and the reference waveform data, so that the abnormality cause to be the cause can be estimated.

More specifically, for example, the coil 9b or the like included in the moving mechanism 9 can be estimated as an abnormality cause, a guide or the like supporting the moving mirror 8 can be estimated as an abnormality cause, or an abnormality cause such as existence of a portion inclined to the device can be estimated.

In addition, since the actual parameter value acquisition unit 11e acquires the actual parameter value using the fitting waveform data, the accuracy of the acquired actual parameter value can be improved, and the cause can be estimated more correctly.

By the way, since accuracy of constant speed control is important in an FTIR interferometer 3, it is likely to consider that a waveform in a constant speed control section of the moving mirror 8 is important.

However, even when the deviation between the actual waveform and the reference waveform in the constant speed control section is confirmed, the amount of information is small, and it is difficult to estimate the abnormality cause.

On the other hand, the actual parameter value acquisition unit 11e of the present embodiment fits the transient section included in the actual waveform indicated by the actual waveform data, and this portion corresponds to the section including the turning point of the moving mirror 8, so that it is possible to estimate various abnormality causes more correctly.

Note that, the present invention is not limited to the embodiment.

For example, the cause estimation unit 11f may estimate the cause of the abnormality occurring in the moving mirror 8 using the actual waveform data indicating or obtained from the actual position of the moving mirror 8 at each time and the reference waveform data indicating or obtained from the target position of the moving mirror 8 at each time. In addition, the movement control unit 11a in this case may control the position of the moving mechanism 9.

Specifically, the cause estimation unit 11f may estimate the abnormality cause using the actual waveform data indicating the actual position of the moving mirror 8 at each time and the reference waveform data indicating the target position of the moving mirror 8 at each time.

In addition, the cause estimation unit 11f may estimate the abnormality cause using the actual waveform data indicating the actual speed of the moving mirror 8 obtained from the actual position of the moving mirror 8 at each time and the reference waveform data indicating the speed of the moving mirror 8 obtained by calculation from the target position of the moving mirror 8 at each time. Although not illustrated, the optical analysis device 1 may include a position sensor that measures the position of the moving mirror 8.

The transfer function is not limited to that described in the embodiment, and may be, for example, a coefficient of U(s) in a correlation formula expressed by the following formula (2), may include a coefficient of U(s) and a constant term in a correlation formula expressed by the following formula (3), or may be various other formulas.

$$Y ( s ) = \frac{{b}_{0}}{{s}^{2} + {a}_{1} s + {a}_{0}} U ( s ) \qquad ( 2 )$$

$$Y ( s ) = \frac{{b}_{0}}{{s}^{3} + {a}_{1} {s}^{2} + s + {a}_{0}} ( U ( s ) - {d}_{0} ) \qquad ( 3 )$$

In the embodiment, the reference parameter value and the actual parameter value are compared for each of the values a₀ and b₀, which are the first parameters, a₁, which is the second parameter, and d₀, which is the third parameter. However, for example, the cause estimation unit 11f may estimate the cause using a combination of a plurality of actual parameter values.

As a specific aspect, for example, one or more abnormal regions corresponding to the abnormality of the movement of the moving mirror 8 is set in a two-dimensional map in which the value of the first parameter is set to one axis and the value of the second parameter is set to the other axis.

In such a configuration, the cause estimation unit 11f may estimate the presence or absence of an abnormality and the cause of the abnormality by comparing a combination of the plurality of actual parameter values with the abnormal region. Note that, the present invention is not limited to the combination of the two parameters, and the abnormal region may be set by combining three or more parameters.

Furthermore, the cause estimation unit 11f may be configured to estimate the cause of the abnormality by applying a machine-learned model to the actual parameter value.

In addition, some or all of the actual waveform data acquisition unit 11b, the reference waveform data acquisition unit 11c, the reference parameter value acquisition unit 11d, the actual parameter value acquisition unit 11e, or the cause estimation unit 11f may be a function to be exerted by a CPU different from the movement control unit 11a.

In addition, the present invention is not limited to the embodiment, and it goes without saying that various modifications can be made without departing from the gist of the present invention.

### INDUSTRIAL APPLICABILITY

According to the optical analysis device of the present invention described above, in a case where a problem occurs in movement of the moving mirror, a cause thereof can be estimated.

### REFERENCE SIGNS LIST

1 optical analysis device
2 infrared light source
3 interferometer
4 measuring cell
5 analysis unit
6 beam splitter
7 fixed mirror
8 moving mirror
9 moving mechanism
9a linear motion guide
9b coil
9c base
10 measurement unit
11 control device
11a movement control unit
11b actual waveform data acquisition unit
11c reference waveform data acquisition unit
11d reference parameter value acquisition unit
11e actual parameter value acquisition unit
11f cause estimation unit
11g cause output unit

1. An optical analysis device that analyzes a target component by guiding light emitted from a light source to a measuring cell and detecting light transmitted through the measuring cell, the optical analysis device comprising:
a moving mirror that reflects the light emitted from the light source while reciprocating;
a moving mechanism that reciprocates the moving mirror;
a movement control unit that controls an applied voltage or an applied current to the moving mechanism; and
a cause estimation unit that estimates a cause of an abnormality affecting the moving mirror by using actual waveform data indicating an applied voltage or an applied current to the moving mechanism at each time and reference waveform data acquired in advance and indicating an applied voltage or an applied current to the moving mechanism at each time.

2. The optical analysis device according to claim 1, wherein
the cause estimation unit estimates, as a cause of the abnormality, information related to a driving source constituting the moving mechanism, information related to a frictional force generated by movement of the moving mirror, or information related to a force applied to the moving mirror regardless of a position of the moving mirror that is reciprocating, and
the optical analysis device further comprises a cause output unit that outputs a cause estimated by the cause estimation unit.

3. The optical analysis device according to claim 1, wherein
a position of the moving mirror at each time and an applied current or an applied voltage to the moving mechanism at each time are able to be expressed using a predetermined transfer function, and the transfer function includes a plurality of parameters corresponding to a plurality of types of the causes, and
the cause estimation unit estimates the cause by comparing each value of the parameters of the transfer function obtained using the reference waveform data with each value of the parameters of the transfer function obtained using the actual waveform data.

4. The optical analysis device according to claim 3, further comprising an actual parameter value acquisition unit that acquires an actual parameter value that is a value of the parameter of the transfer function by fitting the transfer function to the actual waveform data.

5. The optical analysis device according to claim 4, wherein the actual parameter value acquisition unit fits the transfer function to a transient section included in an actual waveform indicated by the actual waveform data.

6. The optical analysis device according to claim 3, wherein one of the plurality of parameters is a parameter that varies according to deviation from a theoretical value of a driving force output from the moving mechanism to the moving mirror, a parameter that varies according to a frictional force generated by movement of the moving mirror, or a parameter that varies according to a force applied to the moving mirror regardless of a position of the moving mirror that is reciprocating.

7. A optical analysis method is a method used by an optical analysis device that analyzes a target component by guiding light emitted from a light source to a measuring cell and detecting light transmitted through the measuring cell, the optical analysis device including: a moving mirror that reflects the light emitted from the light source while reciprocating; and a moving mechanism that reciprocates the moving mirror, the optical analysis method comprising:
estimating a cause of an abnormality affecting the moving mirror using actual waveform data indicating an applied voltage or an applied current to the moving mechanism at each time and reference waveform data acquired in advance and indicating an applied voltage or an applied current to the moving mechanism at each time.

8. (canceled)

9. An optical analysis device that analyzes a target component by guiding light emitted from a light source to a measuring cell and detecting light transmitted through the measuring cell, the optical analysis device comprising:
a moving mirror that reflects the light emitted from the light source while reciprocating;
a moving mechanism that reciprocates the moving mirror;
a movement control unit that controls a position of the moving mechanism; and
a cause estimation unit that estimates a cause of an abnormality affecting the moving mirror by using actual waveform data indicating a position of the moving mirror at each time or obtained from the position, and reference waveform data acquired in advance and indicating a target position of the moving mirror at each time or obtained from the target position.

10. (canceled)
